(19) United States
(12) Patent Application Publication
(10) Pub. No.: US 2002/0004721 A1
(43) Pub. Date: Jan. 10, 2002

(54) System, device and method for intermediating connection to the internet using voice domains, and generating a database used therefor

(76) Inventors: Jung-man Cha, Seoul (KR); Hwa-seong Jeon, Daejeon-city (KR); Lye-Hyun Jo, Daejeon-city (KR)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/827,294

(22) Filed: Apr. 6, 2001

(30) Foreign Application Priority Data
Apr. 6, 2000 (KR) 2000-17928
Nov. 9, 2000 (KR) 2000-66345
Nov. 9, 2000 (KR) 2000-66369

(51) Int. Cl. G10L 21/00

(52) U.S. Cl. 704/270.1

(57) ABSTRACT

A system, a device, and a method for intermediating a connection of an Internet connection system of a user to a Web site by using a voice domain. Database stores data about domain names of a plurality of Web sites and voice domains corresponding to the pronunciations of the domain names. A voice-accessible voice name server receives the pronunciation of the domain name uttered by the user through an Internet connection system, searches the database for a voice domain corresponding to the pronunciation of the domain name, and connects the user to the Web site having a domain name corresponding to the voice domain. Since the user can access the Web site by vocally inputting the corresponding domain name, the user does not experience an inconvenience of having to manually input the domain name. Also, even when a keyboard is not available, the user can easily access his/her intended Web site.

### BACKGROUND OF THE INVENTION

1. Field of the Invention

The present invention relates to a system, a device, and a method for intermediating connection to the Internet using a voice domain, and a method for generating a database of the voice domain, and more particularly to a system, a device, and a method for intermediating connection of an Internet connection system to a Web site corresponding to a domain name pronounced by a user, and a method for generating a database of the voice domain which is used by the intermediating system, the device, and the method. The present application is based on Korean Patent Application Nos. 2000-17928, 2000-66345, and 2000-66369, which are incorporated herein by reference.

2. Description of the Related Art

Generally, Internet users access their desired Web sites by clicking the Web sites they searched from portal sites, or just punching in corresponding domain names when they are aware of the domain names of the Web sites.

When punching in a domain name, an inconvenience occurs in that a user has to memorize alphabetic and numeric (alpha-numeric) domain names, and press key buttons, exactly. There is another inconvenience when accessing the Web site by using a mobile telecommunication terminal such as a mobile phone, PDA, or IMP2000, in that a user has to manipulate a limited number of key buttons, since such devices are usually not provided with complete keyboards.

Although there are rapidly growing demands for home appliances such as refrigerators, TV sets, and home automation systems, having Internet connection functions, it may be difficult, or even impossible to input the domain names through a manipulation of the keyboard, since it is practically impossible to provide complete keyboards to these electronic devices.

### SUMMARY OF THE INVENTION

The present invention has been made to overcome the above-mentioned problems of the related art, and accordingly, it is an object of the present invention to provide a system, a device, and a method for intermediating a connection to a Web site via the Internet by using a voice domain name vocally input by a user.

Another object of the present invention is to provide a method for generating a voice domain database which stores data about voice domains and written domain names and/or IP addresses of the domain names corresponding to the voice domains, for converting the voice domain uttered by a user into a corresponding written domain name and/or IP address.

The above objects are accomplished by an Internet connection intermediating system for connecting an Internet connection system of a user to a Web site according to the present invention, including a database for storing data about domain names and/or IP addresses of a plurality of Web sites, and voice domains corresponding to the pronunciations of the domain names; and a voice name server for receiving the pronunciation of the domain names from the Internet connection system, searching the database for the voice domain corresponding to the pronunciation, and connecting the Internet connection intermediating system to a Web site having the domain name and/or the IP address corresponding to the voice domain.

The above objects are also accomplished by an Internet connection intermediating device according to the present invention, including a data storing portion for storing data about a domain name and/or an IP address of the domain name of at least one Web site, and a voice domain corresponding to the pronunciation of the domain name; a voice perceiving portion for receiving the pronunciation of the domain name uttered by the user, and searching the data storing portion for the voice domain corresponding to the pronunciation of the domain name; and a domain type converting portion for outputting the domain name and/or the IP address of the domain name corresponding to the voice domain searched from the voice perceiving portion.

Since the user can access the Web site by vocally inputting the corresponding domain name, the user does not experience an inconvenience of having to manually input the domain name. Also, even when a keyboard is not available, the user can easily access his/her intended Web site.

The voice domain includes a combination of signals of the pronunciations of respective alphabets and/or numbers that constitute the domain name, or includes signals of the pronunciations of respective alphabetic and numeric words that constitute the domain name. Further, the voice domain of the database can include a combination of signals both of the pronunciations of characters usually used in the domain names, and the pronunciations of characters other than the usually used characters.

According to the present invention, an Internet connection intermediating method for connecting an Internet connection system of a user to a Web site, includes the steps of: i) preparing a database storing data about domain names and/or IP addresses of the domain names of a plurality of Web sites, and voice domains corresponding to the pronunciations of the domain names; ii) receiving the pronunciation of the domain name uttered by the user from the Internet connection system; iii) searching the database for the voice domain corresponding to the pronunciation of the domain name; and iv) connecting the Internet connection system of the user to the Web site having the domain name and/or the IP address of the domain name corresponding to the voice domain.

Meanwhile, the above objects of the present invention are also accomplished by a method for generating a database of a voice domain, comprising the steps of: i) receiving a domain name and/or an IP address of the domain name of a Web site; ii) generating a voice domain which is formed of a voice signal corresponding to the pronunciation of the domain name; and iii) building a database of the voice domain for matching the voice domain with the domain name and/or the IP address of the domain name so that a voice name server, which is able to perceive a voice signal, can convert the voice domain into the domain name and/or the IP address of the domain name.

The domain name can be data in the form of a text and/or in the form of a voice signal in the step i). When the data in the text form is received, the data in the text form is converted into the voice signal, and then such converted voice signal is converted into voice domain data.

As a result, the database of the voice domain can be generated and used efficiently for intermediating the connection to the Internet by using the voice domains.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view showing an Internet connection intermediating system according to a preferred embodiment of the present invention;

FIG. 2 is a flowchart for explaining the operation of the Internet connection intermediating system of FIG. 1;

FIG. 3 is a view showing the Internet connection intermediating system according to another preferred embodiment of the present invention;

FIG. 4 is a flowchart for explaining the operation of the Internet connection intermediating system of FIG. 3;

FIG. 5 is a schematic view showing a modified example of the Internet connection intermediating system of FIG. 3;

FIG. 6 is a block diagram showing the structure of the intermediating system in detail according to the present invention;

FIG. 7 is a view showing a database generating system employed in the Internet connection intermediating system of FIGS. 1, 3, and 5;

FIG. 8 is a flowchart for explaining the process of generating the database according to the modules of FIG. 7; and

FIGS. 9 through 11 show examples of the database structure.

### DETAILED DESCRIPTION OF PREFERRED EMBODIMENT

The present invention will be described in greater detail below with reference to accompanying drawings.

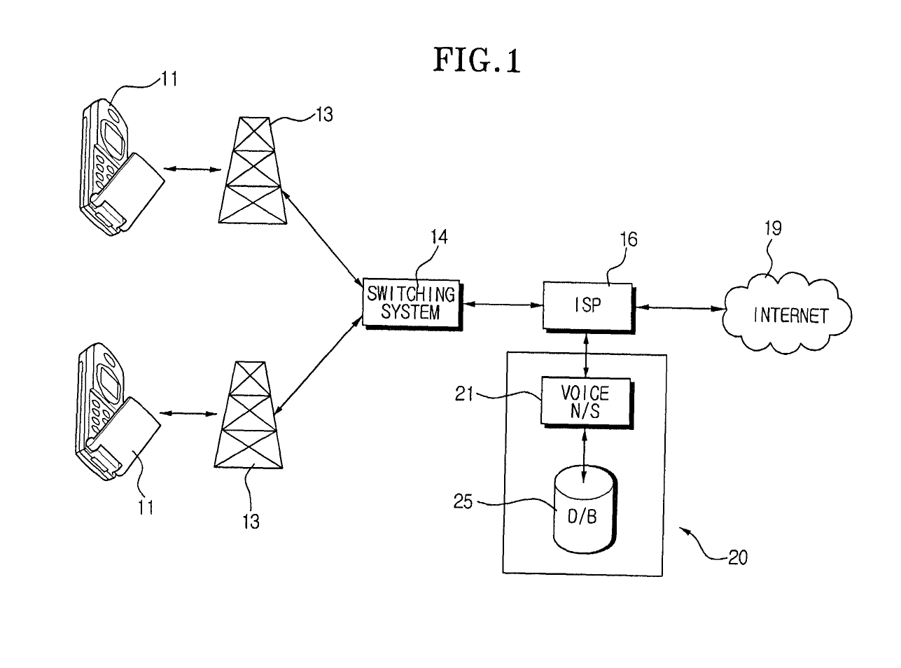

FIG. 1 shows an Internet connection intermediating system according to a preferred embodiment of the present invention, applied to one of the Internet connection systems, i.e., to a mobile phone 11 as an example. The mobile phone 11 is connected to a switching system 14 of a mobile telecommunication operator through a base station 13. The switching system 14 is connected to an Internet Service Provider (ISP) 16, to be connected to the Internet 19 through the Internet connection system of the ISP 16 when a signal transmitted from the mobile phone 11 is for a wireless Internet connection.

The system of the ISP 16 is connected to an Internet connection intermediating system 20 according to the present invention. The Internet connection intermediating system 20 includes a voice name server 21, and a database 25. As will be described in greater detail later, the database 25 stores data about domain names of a plurality of Web sites and/or IP addresses of the domain names, and voice signals corresponding to the pronunciation of the domain names. The voice name server 21 receives a signal from the ISP 16, which corresponds to the user's utterance transmitted from the user's Internet connection system, i.e., from the mobile phone 11, and converts the received voice signal into a corresponding written domain name according to the database 25.

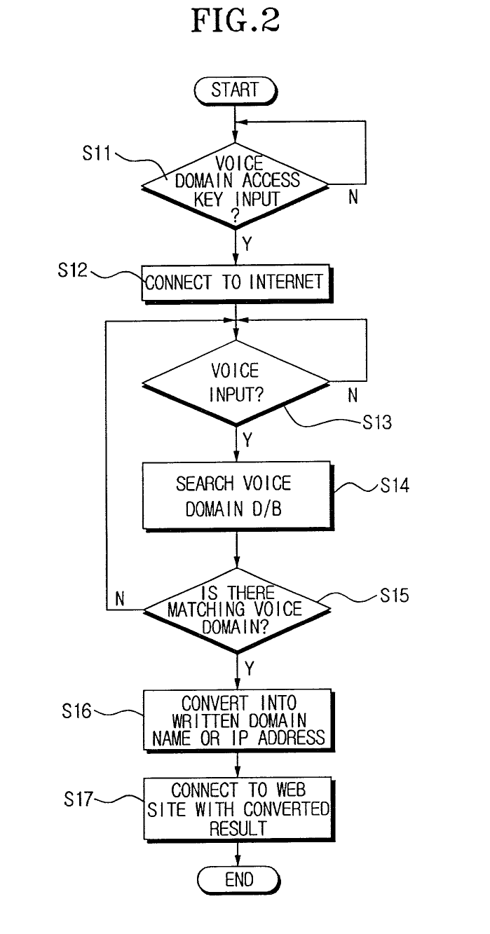

The operation of the Internet connection intermediating system 20 according to the present invention will be described in greater detail with reference to FIG. 2.

The mobile phone 11 has an access key button provided for the user to access the wireless Internet by using voice domain, or a combination of general keys for accessing the wireless Internet. Accordingly, when the user presses the access key button, or manipulates the combination of the keys to access the wireless Internet (step S11), a signal is sent from the mobile phone 11 to the base station 13, and to the switching system 14, and to the ISP 16, successively. Accordingly, the user is connected to the Internet 19 (step S12).

The mobile phone 11 thus gets on-line, and as the user vocally inputs a domain name (step S13), the voice signal is transmitted to the Internet connection intermediating system 20 via the base station 13, the switching system 14, and the ISP 16. Then the voice name server 21 of the Internet connection intermediating system 20 searches the voice domains stored in the database 25 (step S14). If the voice name server 21 finds a voice domain corresponding to the input voice signal, the voice name server 21 provides a corresponding written domain and/or IP address to the ISP 16 (step S16). Then the Internet connection system of the ISP 16 searches the Internet 19 for a web server that provides a Web site corresponding to the written domain name or IP address looked up by the voice name server 21, and accordingly, the mobile phone 11 is connected to the Web site corresponding to the voice domain (step S17).

For example, when the user says \′y\check{a}-hü ′dät ′s\overline{e} ′\overline{o} ′dät ′k\overline{a} ′är\, the voice name server 21 converts the voice signal either into a corresponding written domain name, i.e., into ‘www.yahoo.co.kr’, or into the IP address of the domain name, i.e., ‘210.109.241.8’. As a result, the mobile phone 11 is connected via the Internet 19 to the Web site corresponding to such converted written domain name or the IP address.

As described above, according to the present invention, the voice domain name uttered by the user is converted into the written domain name or the IP address by the voice name server 21. By simply pronouncing the domain name of his/her desired site, the user can access the corresponding Web site.

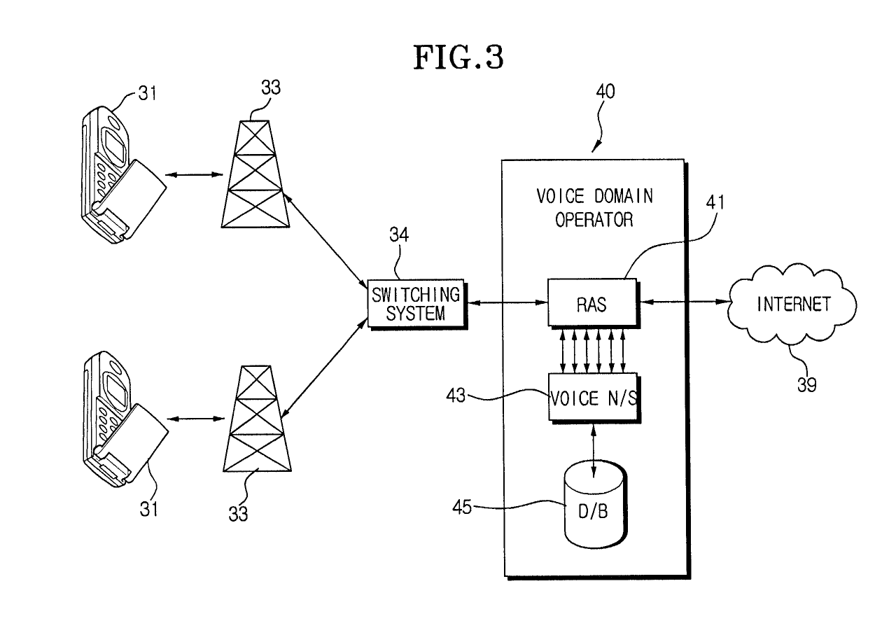

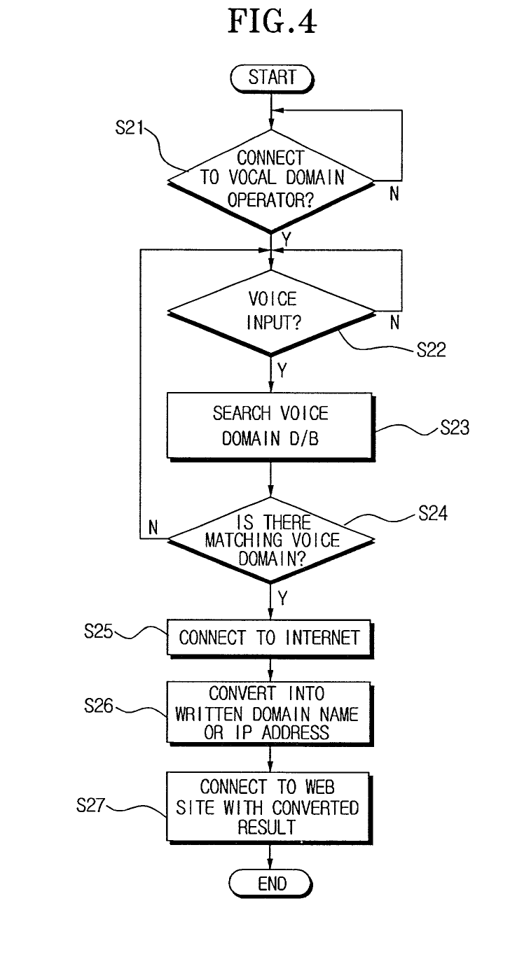

FIG. 3 shows the Internet connection intermediating system according to another preferred embodiment of the present invention, and FIG. 4 is a flowchart for explaining the operation of the Internet connection intermediating system of FIG. 3. According to this preferred embodiment, the operation of the mobile phone 31, the base station 33, and the switching system 34 is identical to that of the first preferred embodiment of the present invention. The difference is that, while the first embodiment describes the Internet connection intermediating system 20 being directly provided to the ISP 16, the second embodiment describes the Internet connection intermediating system 40 being operated by an independent voice domain operator.

The Internet connection intermediating system 40 includes an RAS system 41, a voice name server 43, and a database 45. The structure and operation of the voice name server 43 and the database 45 are identical with the structure and operation of the same according to the first preferred embodiment of the present invention. The RAS system 41 has a predetermined telephone number, and accordingly, the RAS system 41 connects the user to the voice name server 43 upon receipt of the call from the user's mobile phone 31.

Referring to FIG. 4, first, in order to gain access to the wireless Internet 39, the mobile phone user calls the voice domain operator (step S21) in a usual way that he/she makes a call. Upon receipt of the call from the mobile phone 31, the RAS system 41 connects the user to the voice name server 43, and as the user vocally inputs his/her intended domain name (step S22), the voice signal is transferred to the voice name server 43 via the RAS system 41. The voice name server 43 searches the voice domains of the database 45 (step S23), and checks whether there is a voice domain matching the input voice signal (step S24). When there is a voice domain corresponding to the input voice signal, the voice name server 43 connects the mobile phone 31 to the Internet 39 (step S25), and looks up a written domain name or IP address corresponding to the voice domain (step S26). Then, the voice name server 43 searches via the Internet 39 for a Web server having a Web site that corresponds to the written domain name or the IP address looked up from the database 45. Accordingly, the mobile phone 31 is connected to the user's intended Web site (step S27).

As described above, according to the present invention, by simply uttering the voice domain, the user can easily access his/her intended Web site, while the voice domain operator can run his/her own business independently, providing services for a connection to the wireless Internet with a voice domain.

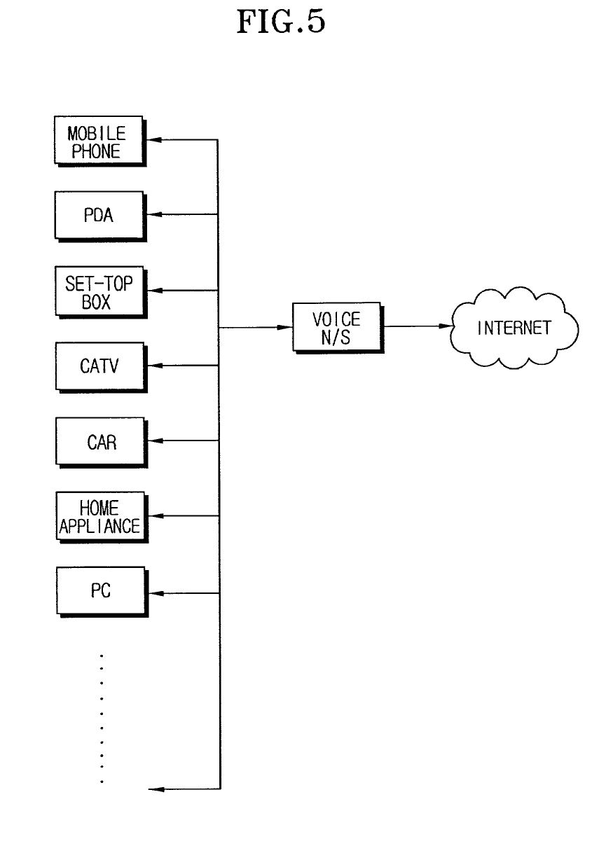

FIG. 5 shows a modified example of the Internet connection intermediating system shown in FIGS. 1 and 3, in which the Internet connection intermediating system is connected to the Internet through electronic devices other than the mobile phone, by using voice domain. As shown in FIG. 5, the Internet connection intermediating system according to the present invention can be applied not only to the wireless Internet terminals such as mobile phones, PDAs, or the like, but is also applicable to all the other devices for Internet connection such as an Internet accessible set-top box using TVs, CATVs, cars, home appliances, and PCs, or the like. Here, a precondition for an Internet connection is that all the devices should be provided with a voice receiver for receiving the voice of the user.

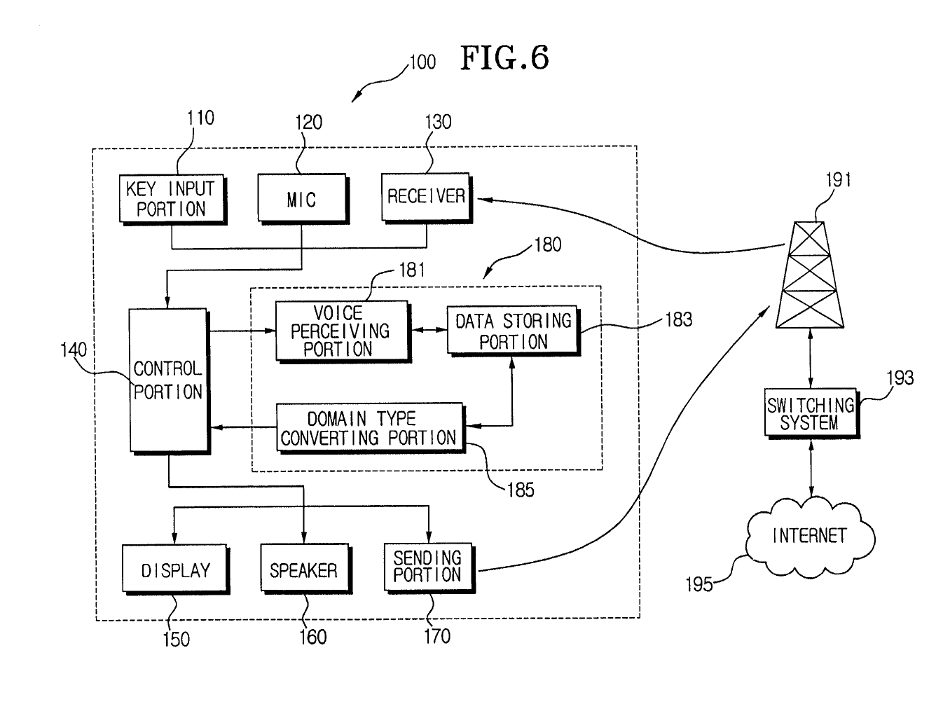

FIG. 6 is a view showing the Internet connection intermediating device according to the present invention, which is employed in the mobile phone accessible to the wireless Internet. As described above in the description of the preferred embodiment, the mobile phone 100 is connected to the switching system 193 of the mobile communication operator. The switching system 193 connects the mobile phone 100 to the Internet 195 through the ISP (not shown).

The mobile phone 100 includes a control portion 140 functioning as a CPU for controlling operations of the respective components, a key input portion 110 having a plurality of key buttons arranged on the front side of the mobile phone 100 for inputting user's selection to the control portion 140, a microphone 120 for receiving the voice of the user, a receiving portion 130 for receiving a signal from the base station 191, a display 150 formed of a Liquid Crystal Display for displaying various information on a screen for a user's notice, a speaker 160 for outputting the voice from a sender to the user, and a sending portion 170 for sending signals of voices or various data from the user to the base station 191.

Further, the mobile phone 100 has an Internet connection intermediating device 180 for connecting to the Internet 195 by using voice domains. The Internet connection intermediating device 180 can be formed either of one chip, or a plurality of chips. The Internet connection intermediating device 180 includes a voice perceiving portion 181 for receiving and perceiving voice signals from the control portion 140, a data storing portion 183 for storing database of the voice domains therein, and a domain type converting portion 185 for converting the type of the voice domain.

The data storing portion 183 stores a database of the domain names of a plurality of Web sites, IP addresses of the domain names, and voice signals corresponding to the pronunciation of the domain names. The voice perceiving portion 181 perceives a pattern of the voice signals input from the receiver 130, and compares the received signals with the voice domains stored in the data storing portion 183. The domain type converting portion 185 converts the voice domain into a corresponding written domain name or its IP address, according to the contents stored in the data storing portion 183 and according to the signals received from the voice perceiving portion 181.

The operation of the Internet connection intermediating device of this embodiment is identical to the operation of the Internet connection intermediating device of the embodiment of FIG. 1, which is illustrated in FIG. 2. That is, when the user presses an access key button or manipulates key buttons for connecting to the wireless Internet (step S11), a signal is generated from the mobile phone 100 and input to the control portion 140. After that, the signal is output to the base station 191 via the sending portion 170. As the signal reaches the Internet 195 via the switching system 193 and the ISP, the mobile phone 100 is connected to the Internet 195 (step S12).

In a state that the mobile phone 100 is connected to the wireless Internet 195, as a user pronounces his/her desired domain name, the voice is input to the receiving portion 130 (step S13), and the control portion 140 inputs a corresponding voice signal in the voice perceiving portion 181 of the Internet connection intermediating device 180. The voice perceiving portion 181 perceives the pattern of the input voice, and searches a voice domain field in the data storing portion 183 (step S14). When a corresponding voice domain is found (step S15), the address of the voice domain is output to the domain type converting portion 185. Accordingly, the domain type converting portion 185 finds a written domain name or an IP address corresponding to the voice domain according to the received address of the voice domain, and converts the voice domain into a written domain name of IP address (step S16). Such converted domain name or the IP address is output to the control portion 140, and the control portion 140 outputs such converted domain name or the IP address to the base station 191. As a result, the mobile phone 100 is connected to the Internet 195 via the switching system 193 and the ISP (step S17).

As described above, according to the present invention, simply saying a domain name can connect the user to a user's intended Web site. Further, since the Internet connection intermediating device 180 is formed of one chip, the Internet connection intermediating device 180 can be employed in almost every communication device, such as mobile phones 100, PDAs, PCs, and home appliances having Internet connection equipment, or the like.

Although the Internet connection intermediating device 180 of this embodiment includes the respective components 181, 183, and 185 equipped within one chip, it is not limited to this case only. For example, the data storing portion 183 itself can be made of one memory, while the voice perceiving portion 181 and the domain type converting portion 185 can be a software for perceiving the voice signals of respective pattern, and a software for handling the database within the memory, respectively.

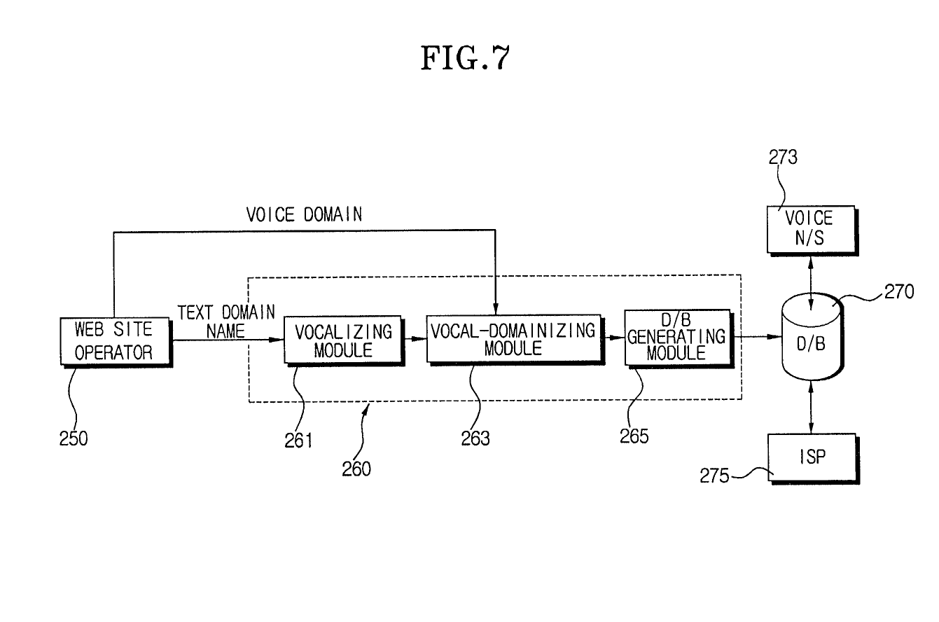

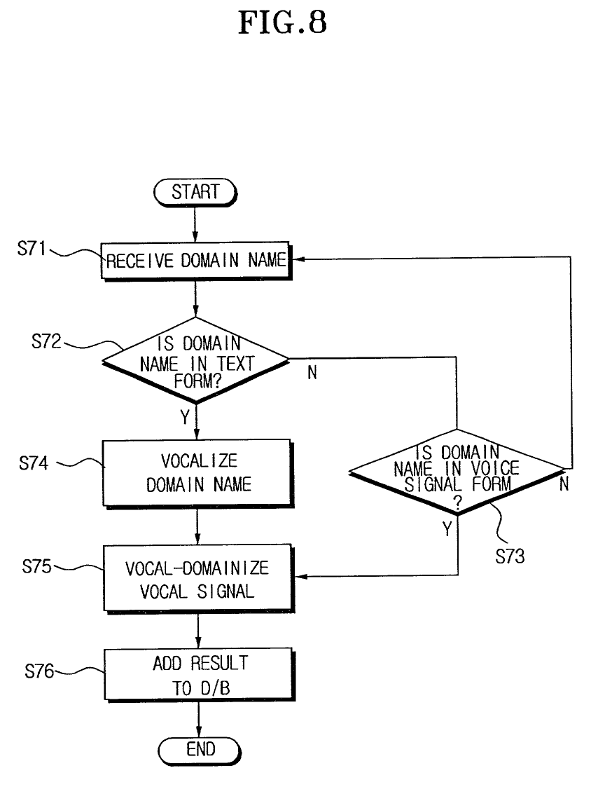

FIG. 7 is a view showing the database generating system used in the Internet connection intermediating system and device of FIGS. 1, 3, and 5. FIG. 8 is a flowchart for explaining the process of database generation.

The voice domain database generating device 260 includes a vocalizing module 261, a vocal-domainizing module 263, and a D/B generating module 265. The database generating device 260 receives domain names of the Web sites from the Web site operators. The domain names can either be input manually upon request of the Web site operators for the D/B generation, or can be input through the networks linked to the Internet 195. The database generating device 260 generates a database 270 of the voice domains by using the input domain names, and provides the database 270 either to a voice name server 273 operated by the voice domain operator, or to the ISP 275 offering voice domain services.

Referring to FIG. 8, a domain name is received from the Web site operator 250 (step S71). Then it is determined whether the domain name is in the form of a voice signal or a text signal (steps S72 and S73). For example, when the input domain name is input in the form of a combination of written letters and/or numbers such as ‘www.yahoo.co.kr’, the domain name is determined to be in a text form. Meanwhile, when the domain name is input in the form of a voice uttered by the user, the domain name is determined to be in a voice signal form.

When the domain name in the text form is input, the vocalizing module 261 generates a voice signal corresponding to the input domain name (step S74). Also, the vocal-domainizing module 263 processes such vocalized signal into a form suitable for database generation, and generates a corresponding voice domain (step S75). Such generated voice domain is additionally input and thus stored in the database 270 by the D/B generating module 265, together with the original domain name (step S76). The database 270 is built by repeating the above processes with respect to every domain name of the Web site.

When the voice signal type domain name is input, the domain name is directly input to the vocal-domainizing module 263, skipping the vocalizing module 261. Then the domain name is built into the database 270 through the same processes as described above. The database generated as above, is provided to the ISP 275, or to the Internet connection intermediating system or device.

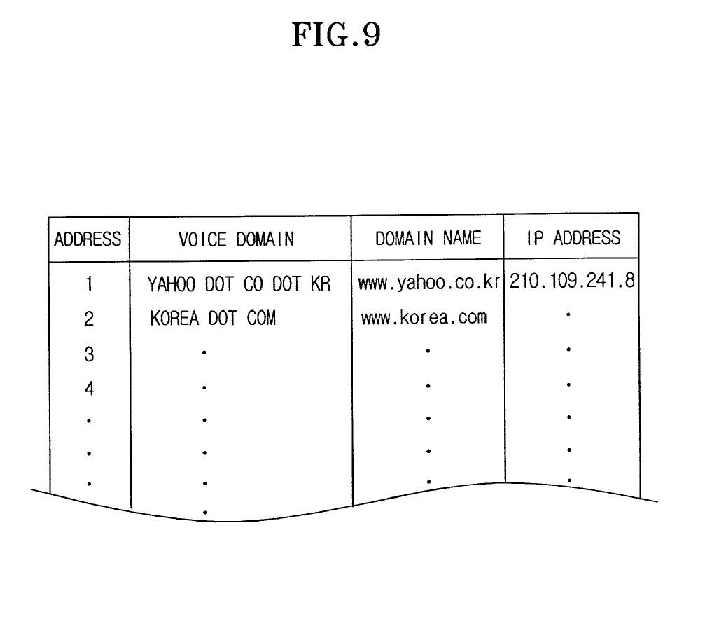

FIGS. 9 through 11 are exemplary views showing the structure of the database 270 generated by the above-described processes.

FIG. 9 shows the database formed of four fields, i.e., an address field, a voice domain field, a domain name field, and an IP address field. The address of the address field is a serial number of the data, indicating the location of the data. In the voice domain field, the signal corresponding to the pronunciation of the domain name is stored. Further, in the domain name field, a written domain name corresponding to the voice signal is stored. Finally, in the IP address field, the IP address of the domain name is stored.

According to this embodiment, when the user pronounces the alphanumeric domain name, such pronunciation of the user is perceived. For example, if the user pronounces \′y\check{a}-hü ′dät ′s\overline{e} ′\overline{o} ′dät ′k\overline{a} ′är\, the user is connected to the Web site having a written domain name, “www.yahoo.co.kr”.

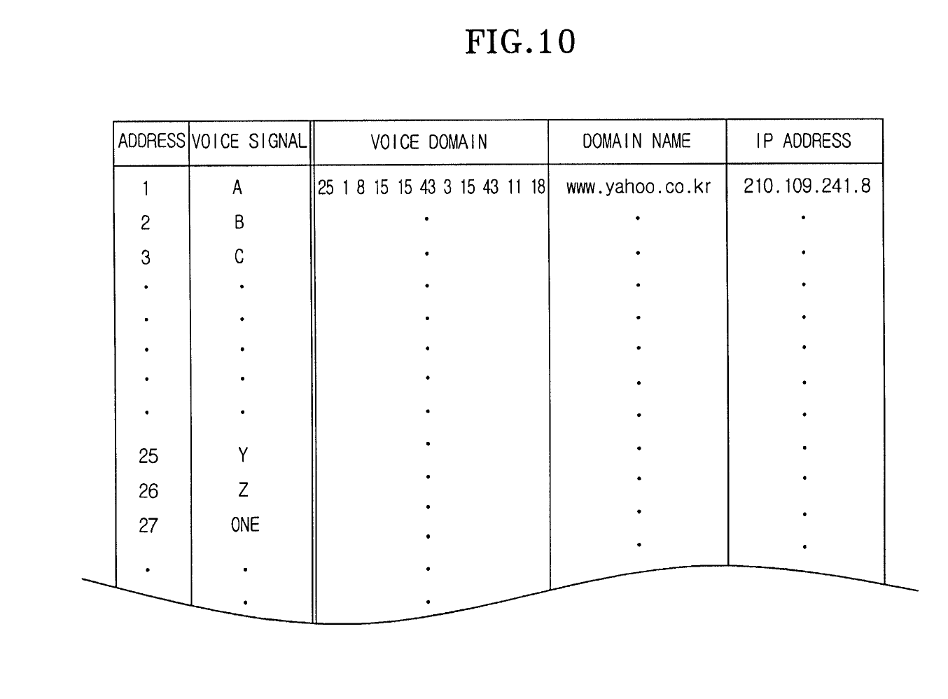

FIG. 10 shows the database formed of five fields, i.e., an address field, a voice signal field, a voice domain field, a domain name field, and an IP address field. The address of the address field is a serial data number indicating the location of the data. In the voice signal field, a voice signal corresponding to a pronunciation of each alpha-numeric word of a domain name, is stored. Further, in the voice domain field, a signal corresponding to a pronunciation of each alpha-numeric character is stored, having an address of its own. A domain name corresponding to the voice domain is stored in the domain name field, while an IP address of the domain name is stored in the IP address field.

According to this embodiment, the pronunciation of each alphabet of the domain name can also be perceived. That is, the pronunciation \40 w\overline{i}\ is stored in the voice domain field with the address of “25”, and the pronunciation \′\overline{a}\ is stored in the voice domain field with the address of “1”, and \′\overline{a}ch\ is the address of “8”, and so on. Accordingly, when the user pronounces \′w\overline{i}\ \′\overline{a}\ \′\overline{a}ch\ \′\overline{o}\ \′\overline{o}\ \′dät\ \′s\overline{e}\ \′\overline{o}\ \′dät\ \′k\overline{a}┘ \′är\, the addresses of the respective pronunciations are combined with each other to form an address like, “25 1 8 15 15 43 3 15 43 11 18’, and stored. Such combined and stored address corresponds to the written domain name, i.e., “www.yahoo.co.kr”. Accordingly, when the user pronounces the domain name character by character, the voice name server 273 segments and perceives the voice of the user into the pronunciation of each alphabet, generates a new voice domain corresponding to the perceived voice according to the database, and compares the new voice domain with the voice domains previously input in the database. When the new voice domain matches the voice domain previously input in the database, the corresponding written domain name is output, and accordingly, the user is connected to his/her intended Web site.

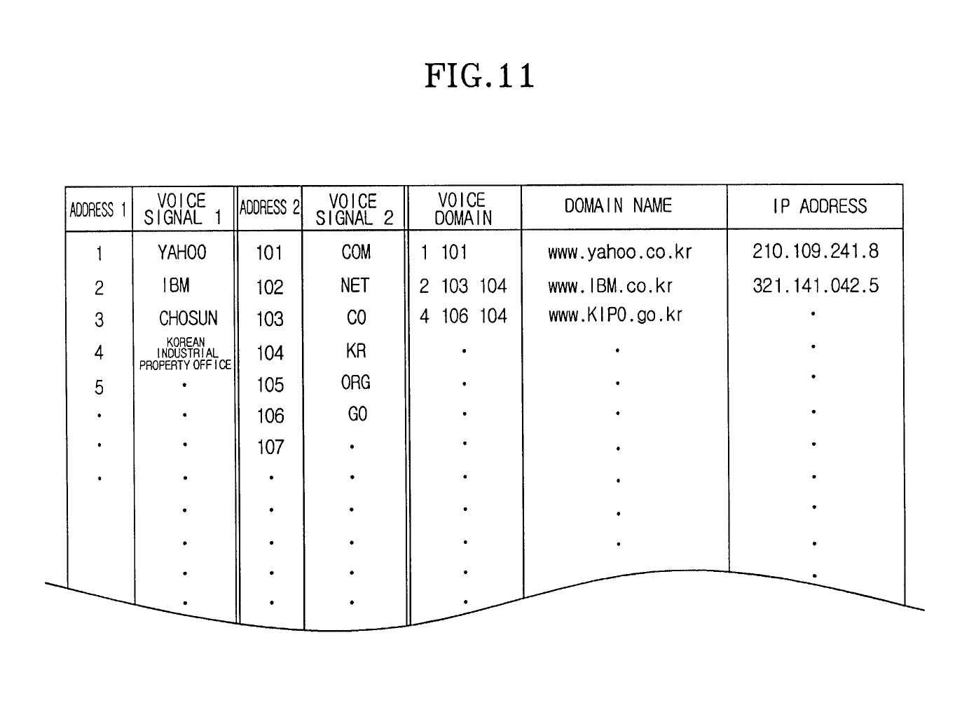

FIG. 11 shows the database formed of seven fields. According to this embodiment, signals corresponding to the pronunciations of the commonly used domain names, i.e., the Top Level Domains, such as ‘com’ for commercial organization, ‘net’ for network supporting center, ‘co’ for corporation, ‘kr’ for Korea, ‘org’ for other organizations, and ‘gov’ for government, or the like, are stored with addresses of their own. Also, signals corresponding to the pronunciations of the words of the domain names which are frequently used by the user excluding the Top Level Domains, such as ‘yahoo’ for the name of a search engine, ‘IBM’ for the name of a computer company, and ‘chosun’ for the name of a Korean national newspaper, or the like, are stored with addresses of their own. Since the domain names are generally a combination of the Top Level Domains and words determined by domain registrants, by separately storing the signals of the pronunciations of the respective Top Level Domains and the other words and combining the signals as necessary, the data storage can be reduced.

For example, the pronunciation \′\overline{i}′b\overline{e}′em\ is stored with the address of “2”, \′s\overline{e}′\overline{o}\ with “103”, and \′k\overline{a}′är\ with “104”, and so on. Accordingly, when the user pronounces \′\overline{i} ′b\overline{e} ′e, ′dät ′s\overline{e} ′\overline{o} ′dät ′k\overline{a} ′är′, the addresses of the respective pronunciations are combined into ‘2 103 104’, corresponding to the written domain name of ‘www. IBM. co. kr’. When the user pronounces his/her intended domain name, the voice name server 273 segments and perceives the pronunciation of the domain name into the Top Level Domains and the other words, generates a new voice domain corresponding to the pronunciation based on the database, and compares the new voice domain with the voice domains previously input to the database. When the new voice domain matches the voice domain previously input to the database, the corresponding domain name is output, and accordingly, the user is connected to his/her intended Web site.

As shown in the examples of FIGS. 9 through 11, the database stores the IP addresses together with the domain names. Here, since either one of the IP address and the domain name could enable the connection to the Internet, the database may store one of the domain name and the IP address.

When building the database of the voice domains and the IP addresses, the Web site is provided with a voice domain name. Accordingly, the present invention has an advantage in that the voice domain name itself enables a connection to the Internet without a written domain name. Accordingly, for those who operate wireless Internet-only Web sites, they have an advantage in that they can establish voice domain names to distinguish each Web site. Also, for those who operate the database, they have the advantages of storage reduction and efficient management.

As described above, according to the present invention, since the user can access his/her intended Web site by vocally inputting a corresponding domain name, the user does not experience the inconvenience of having to manually input the domain name, and also can access the Web site easily, even when a keyboard is not available to him/her. Further, a database of voice domains can be easily generated, and the database can be used to intermediate a connection to the Internet, efficiently. Further, since the Internet connection intermediating device can be either made of one chip, or made in the form of software, the Internet connection intermediating device is applicable to various types of Internet connection systems.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. An Internet connection intermediating system for connecting an Internet connection system of a user to a Web site, comprising:
a database for storing data about respective domain names and/or respective IP addresses of a plurality of Web sites, and voice domains corresponding to respective pronunciations of the respective domain names; and
a voice name server for receiving the pronunciation of one of the respective domain names from the Internet connection system, searching the database for the voice domain corresponding to the respective pronunciation, and connecting the Internet connection intermediating system to a Web site having the respective domain name and/or the respective IP address corresponding to the voice domain.

2. The Internet connection intermediating system as claimed in claim 1, wherein the voice domains include a combination of signals of pronunciations of respective letters and/or respective numbers that constitute the respective domain names.

3. The Internet connection intermediating system as claimed in claim 1, wherein the voice domains include signals of pronunciations of respective alphabetic and respective numeric words that constitute the respective domain names.

4. The Internet connection intermediating system as claimed in claim 1, wherein the voice domains of the database include a combination of signals both of pronunciations of characters usually used in the respective domain names, and pronunciations of characters other than the usually used characters.

5. An Internet connection intermediating device, comprising:
a data storing portion for storing data about respective domain names and/or respective IP addresses of the domain names of at least one Web site, and voice domains corresponding to respective pronunciations of the respective domain names;
a voice perceiving portion for receiving the pronunciation of one of the respective domain names uttered by a user, and searching the data storing portion for the voice domain corresponding to the received pronunciation of the domain name; and
a domain type converting portion for outputting the respective domain names and/or the respective IP addresses of the domain names corresponding to the voice domains searched from the voice perceiving portion.

6. The Internet connection intermediating device as claimed in claim 5, wherein the voice domains stored in the data storing portion include a combination of signals of respective pronunciations of respective letters and/or respective numbers that constitute the respective domain names.

7. The Internet connection intermediating device as claimed in claim 5, wherein the voice domains stored in the data storing portion include signals of respective pronunciations of respective alphabetic and respective numeric words that constitute the respective domain names.

8. The Internet connection intermediating device as claimed in claim 5, wherein the voice domains stored in the data storing portion include a combination of signals both of pronunciations of characters usually used in the domain names, and pronunciations of characters other than the usually used characters.

9. An Internet connection intermediating method for connecting an Internet connection system of a user to a Web site, comprising the steps of:
i) preparing a database for storing data about respective domain names and/or respective IP addresses of the domain names of a plurality of Web sites, and voice domains corresponding to respective pronunciations of the domain names;
ii) receiving the pronunciation of one of the respective domain names uttered by a user from the Internet connection system;
iii) searching the database for the voice domain corresponding to the received pronunciation of the domain name;
iv) connecting the Internet connection system of the user to the Web site having the respective domain names and/or the respective IP addresses of the domain names corresponding to the voice domains.

10. The Internet connection intermediating method as claimed in claim 9, wherein the voice domains stored in the database include a combination of signals of respective pronunciations of respective letters and/or respective numbers that constitute the respective domain names.

11. The Internet connection intermediating method as claimed in claim 9, wherein the voice domains stored in the database include signals of respective pronunciations of respective alphabetic and respective numeric words that constitute the respective domain names.

12. A method for generating a database of voice domains, comprising the steps of:
i) receiving respective domain names and/or respective IP addresses of the domain names of a Web site;
ii) generating voice domains which are formed of a voice signal corresponding to the respective pronunciations of the respective domain names; and
iii) building a database of the voice domains for matching the voice domains with the respective domain names and/or the respective IP addresses of the domain names so that a voice name server, which is able to perceive a voice signal, can convert the voice domains into the respective domain names and/or the respective IP addresses of the domain names.

13. The database generating method as claimed in claim 12, wherein the respective domain names are data in the form of a text and/or in the form of a voice signal in the step i).

14. The database generating method as claimed in claim 13, wherein, when the data in the text form is received in the step i), the step ii) includes the steps of:
converting the data in the text form into the voice signal; and
converting the voice signal into voice domain data.

15. The database generating method as claimed in claim 12, wherein the voice domains of the database include a combination of signals of respective pronunciations of respective letters and/or respective numbers that constitute the respective domain names.

16. The database generating method as claimed in claim 12, wherein the voice domains of the database include signals of respective pronunciations of respective alphabetic and respective numeric words that constitute the respective domain names.

17. The database generating method as claimed in claim 12, wherein the voice domains of the database include a combination of both signals of pronunciations of Top Level Domains (TLD) of the respective domain names, and signals of pronunciations of names of the respective domain names excluding the Top Level Domains (TLD).
